(19) United States
(12) Patent Application Publication
(10) Pub. No.: US 2024/0426600 A1
(43) Pub. Date: Dec. 26, 2024

(54) SHAPE MEASURING DEVICE AND SHAPE MEASURING METHOD

(71) Applicant: Tokyo Seimitsu Co., Ltd., Tokyo (JP)

(72) Inventor: Kyohei HAYASHI, Tsuchiura-city (JP)

(73) Assignee: Tokyo Seimitsu Co., Ltd., Tokyo (JP)

(21) Appl. No.: 18/827,141

(22) Filed: Sep. 6, 2024

Related U.S. Application Data
(63) Continuation of application No. PCT/JP2023/007521, filed on Mar. 1, 2023.

(30) Foreign Application Priority Data
Mar. 8, 2022 (JP) 2022-035644

(51) Int. Cl. G01B 11/24

(52) U.S. Cl. CPC G01B 11/24

(57) ABSTRACT

The shape measuring device includes: a relative movement unit that relatively moves a probe along a surface to be measured and scans the surface with measurement light; a detecting unit that, while the relative movement is performed, repeatedly detects, multiplexed light generated by a multiplexing unit for each of measurement point of the surface on which the measurement light is incident; a distance calculating unit that detects a beat frequency from a detection signal of the multiplexed light detected by the detecting unit and calculates a distance from the probe to the measurement point based on the beat frequency for each measurement point; a position calculating unit that calculates a position of each measurement point; and a position correcting unit that corrects the position of the measurement point based on a Doppler shift amount of the measurement light reflected at the measurement point, for each measurement point.

### CROSS-REFERENCE TO RELATED APPLICATIONS

The present application is a Continuation of PCT International Application No. PCT/JP2023/007521 filed on Mar. 1, 2023 claiming priority under 35 U.S.C § 119(a) to Japanese Patent Application No. 2022-035644 filed on Mar. 8, 2022. Each of the above applications is hereby expressly incorporated by reference, in its entirety, into the present application.

### BACKGROUND OF THE INVENTION

### Field of the Invention

The present invention relates to a shape measuring device and a shape measuring method for measuring the shape of a surface to be measured using a wavelength swept light source.

### Description of the Related Art

A profile measurement device that performs profile measurement is known as a shape measuring device that measures a shape (a surface shape, a contour shape, or the like) of a surface to be measured of a measurement target object in a noncontact manner (see Patent Literature 1). To measure the shape of the surface to be measured, the profile measurement device repeatedly executes, for each of measurement points of the surface to be measured, distance detection from the probe to the measurement point and position detection for the measurement point based on a result of the distance detection, while relatively moving a probe of a noncontact distance meter along the surface to be measured in a state of being spaced at an interval from the surface to be measured.

As the noncontact distance meter, a wavelength swept type noncontact distance

meter using a wavelength swept light source is known (see Patent Literature 2). The wavelength swept type noncontact distance meter divides wavelength swept light emitted from the wavelength swept light source into measurement light and reference light, emits the measurement light from the probe toward the surface to be measured, and emits the reference light toward a reference surface. The wavelength swept type noncontact distance meter detects, with a photodetector, multiplexed light of the measurement light reflected on the surface to be measured and enters to the probe, and the reference light reflected on the reference surface. At this time, a difference occurs between wavelengths (frequencies) of the measurement light and the reference light on the photodetector because of a reaching time difference between the measurement light and the reference light from the wavelength swept light source to the photodetector, and the frequency difference between the measurement light and the reference light is detected as a beat frequency by the photodetector. The wavelength swept type noncontact distance meter performs a frequency analysis of a detection signal detected by the photodetector to detect the beat frequency and calculates a distance from the probe to the surface to be measured based on the beat frequency.

### CITATION LIST

### Patent Literature

Patent Literature 1: Japanese Patent Application Laid-Open No. 2020-56637
Patent Literature 2: Japanese Patent Application Laid-Open No. 2021-32734

### SUMMARY OF THE INVENTION

When the profile measurement described in Patent Literature 1 is performed using the wavelength swept type noncontact distance meter described in Patent Literature 2, if the surface to be measured is a nonhorizontal surface like a curved surface, the measurement light is not perpendicularly incident on the surface to be measured from the probe, but obliquely incident on the surface. If the probe is relatively moved along the surface to be measured in this state, this causes a Doppler shift in which the frequency of the measurement light reflected at the measurement point of the surface to be measured is shifted by the Doppler effect. In the wavelength swept type noncontact distance meter, if the frequency of the measurement light independently changes because of a factor other than the distances between the measurement points and the probe, since an error occurs in a measurement result of a distance from the probe to the measurement points, an error also occurs in position detection results of the measurement points. For this reason, in the profile measurement for the surface to be measured using the wavelength swept type noncontact distance meter, an error may occur in a measured shape of the surface to be measured.

The present invention has been devised in view of such circumstances, and aims to provide a shape measuring device and a shape measuring method capable of reducing an error in a measured shape of a surface to be measured due to the Doppler shift.

A shape measuring device for achieving the object of the present invention includes: a wavelength swept light source; a light dividing configured to split light emitted from the wavelength swept light source into measurement light and reference light; a probe configured to emit the measurement light split by the light dividing unit toward a surface to be measured and receive the measurement light reflected on the surface to be measured; a reference surface configured to reflect the reference light split by the light dividing unit; a multiplexing unit configured to generate multiplexed light of the measurement light reflected on the surface to be measured and received by the probe, and the reference light reflected on the reference surface; a relative movement unit configured to relatively move the probe along the surface to be measured in a state of being spaced an interval apart from the surface to be measured, and scan the surface to be measured with the measurement light; a detecting unit configured to, while relative movement of the prove is performed, repeatedly detect the multiplexed light generated by the multiplexing unit, for each measurement point on the surface to be measured on which the measurement light is incident; a distance calculating unit configured to detect a beat frequency from a detection signal of the multiplexed light detected by the detecting unit and calculate a distance from the probe to the measurement point based on the beat frequency, for each measurement point; a position calculating unit configured to calculate a position of the measurement point based on a calculation result of the distance calculating unit corresponding to the measurement point, for each measurement point; and a position correcting unit configured to correct the position of the measurement point calculated by the position calculating unit based on a Doppler shift amount of the measurement light reflected at the measurement point, for each measurement point.

With the shape measuring device, it is possible to correct an error in the positions of the measurement points due to the Doppler shift.

In the shape measuring device according to another aspect of the present invention, the relative movement unit relatively moves, based on shape data of the surface to be measured created in advance, the probe along the surface to be measured in a state of being spaced a fixed interval apart from the surface to be measured which is assumed from the shape data. Accordingly, it is possible to detect an error between a shape of an ideal surface to be measured which is assumed from the shape data, and a shape of an actual surface to be measured.

In the shape measuring device according to another aspect of the present invention, the probe makes the measurement light incident on the surface to be measured from an oblique direction. Accordingly, it is possible to correct an error in the positions of the measurement points due to the Doppler shift.

The shape measuring device according to another aspect of the present invention includes a scanning direction vector calculating unit configured to calculate, for each measurement point, a magnitude of a scanning direction vector of the measurement light for scanning the surface to be measured, the scanning direction vector being parallel to a tangential direction of the surface to be measured at the measurement point, wherein in a case where a direction of the measurement light between the probe and the measurement point is represented as a measurement light direction, the position correcting unit calculates, for each measurement point, the Doppler shift amount based on a component parallel to the measurement light direction of the scanning direction vector calculated by the scanning direction vector calculating unit and a wavelength or a frequency of the measurement light.

A shape measuring method for achieving the object of the present invention includes: a light dividing step of dividing light emitted from a wavelength swept light source into measurement light and reference light, to emit the measurement light from a probe toward a surface to be measured and to emit the reference light toward a reference surface; a multiplexing step of generating multiplexed light of the measurement light reflected on the surface to be measured and received by the probe, and the reference light reflected on the reference surface; a relative movement step of relatively moving the probe along the surface to be measured in a state of being spaced an interval apart from the surface to be measured, and scanning the surface to be measured with the measurement light; a detecting step of, during the relative movement step, repeatedly detecting the multiplexed light generated in the multiplexing step, for each measurement point of the surface to be measured on which the measurement light is incident; a distance calculating step of detecting a beat frequency from a detection signal of the multiplexed light detected in the detecting step and calculating a distance from the probe to the measurement point based on the beat frequency, for each measurement point; a position calculating step of calculating a position of the measurement point based on a calculation result of the distance calculating step corresponding to the measurement point, for each measurement point; and a position correcting step of collecting the position of the measurement point calculated in the position calculating step based on a Doppler shift amount of the measurement light reflected at the measurement point, for each measurement point.

The present invention may reduce an error in a measured shape of a surface to be measured due to a Doppler shift.

### BRIEF DESCRIPTION OF THE DRAWINGS

FIG. 1 is a schematic diagram of a profile measurement device that performs profile measurement for a curved surface-shaped surface to be measured of an object to be measured.

FIG. 2 is a schematic diagram illustrating an optical configuration of a wavelength swept type interferometer.

FIG. 3 is a functional block diagram of a control device.

FIG. 4 is an explanatory diagram for explaining a problem in performing the profile measurement for the curved surface-shaped surface to be measured, in a noncontact manner.

FIG. 5 is an explanatory diagram for explaining calculation of a scanning direction vector by a scanning direction vector calculating unit.

FIG. 6 is a flowchart illustrating a flow of profile measurement processing for the surface to be measured by the profile measurement device.

FIG. 7 is a diagram illustrating an example of the surface to be measured for which the profile measurement has been performed by the profile measurement device.

FIG. 8 is a graph comparing positions of measurement points and corrected measurement points obtained by performing, with the profile measurement device, profile measurement within a measurement range of the surface to be measured illustrated in FIG. 7, and positions of the measurement points obtained by measuring the measurement points with a contact type distance meter.

### DESCRIPTION OF THE EMBODIMENTS

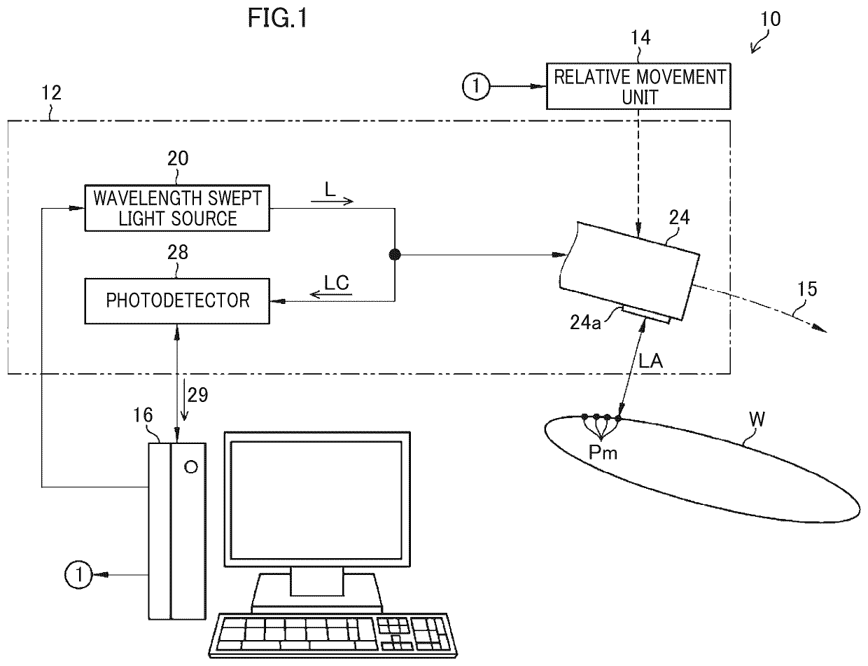

FIG. 1 is a schematic diagram of a profile measurement device 10 that performs, in a noncontact manner, profile measurement for a curved surface-shaped (nonhorizontal surface-like) surface to be measured W of an object to be measured. Note that, in the present embodiment, a blade surface is explained as an example of the surface to be measured W. As illustrated in FIG. 1, the profile measurement device 10 includes a wavelength swept type interferometer 12, a relative movement unit 14, and a control device 16. The profile measurement device 10 is equivalent to the shape measuring device of the present invention.

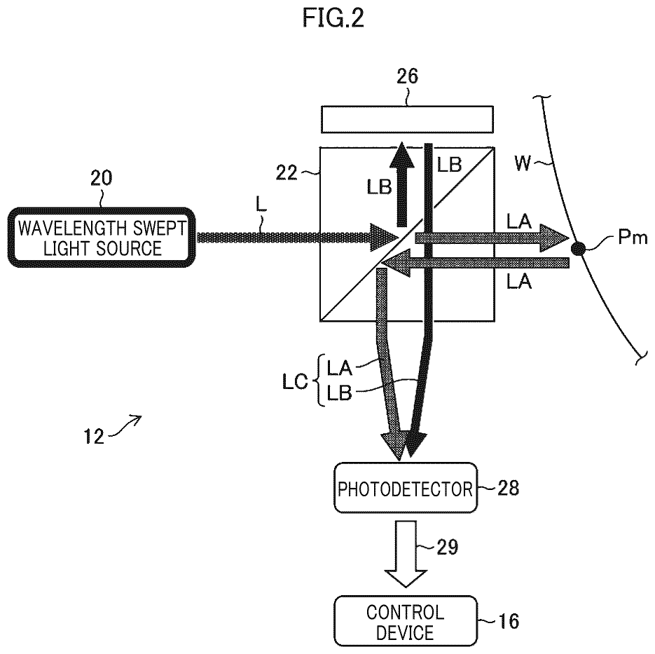

FIG. 2 is a schematic diagram illustrating an optical configuration of the wavelength swept type interferometer 12. As illustrated in FIG. 2 and FIG. 1 referred to above, the wavelength swept type interferometer 12 constitutes, in conjunction with the control device 16 explained below, a wavelength swept type noncontact distance meter that measures distances to measurement points Pm on the surface to be measured W, in a noncontact manner. The wavelength swept type interferometer 12 includes a wavelength swept light source 20, a beam splitter 22, a probe 24, a reference surface 26, and a photodetector 28.

The wavelength swept light source 20 emits wavelength swept light L toward the beam splitter 22 under the control of the control device 16. The wavelength swept light L is, for example, light whose wavelength changes in a sinusoidal waveform at a fixed wavelength sweep period (a fixed wavelength sweep frequency) and in a fixed wavelength band according to elapse of time.

For example, a half mirror is used as the beam splitter 22. The beam splitter 22 splits the wavelength swept light L input from the wavelength swept light source 20, into measurement light LA and reference light LB. The beam splitter 22 emits the measurement light LA toward an incidence and emission end 24a of the probe 24, and emits the reference light LB toward the reference surface 26. In this case, the beam splitter 22 functions as the light dividing unit of the present invention.

The probe 24 (also referred to as a “measurement head”) includes the incidence and emission end 24a that, while the profile measurement for the surface to be measured W is performed, emits the measurement light LA split by the beam splitter 22 toward the surface to be measured W. The measurement light LA reflected on the surface to be measured W is incident on the incidence and emission end 24a. Here, at least any one of the beam splitter 22, the reference surface 26, and the photodetector 28 may be housed inside the probe 24.

As the reference surface 26, a reflection mirror is used, for example. The reference surface 26 reflects the reference light LB made incident from the beam splitter 22 toward the beam splitter 22.

The beam splitter 22 generates multiplexed light LC (interference light) of the measurement light LA incident on the incidence and emission end 24a of the probe 24 after being reflected on the surface to be measured W, and the reference light LB reflected on the reference surface 26. Then, the beam splitter 22 emits the multiplexed light LC to the photodetector 28. In this case, the beam splitter 22 functions as the multiplexing unit of the present invention.

The photodetector 28 is equivalent to the detecting unit of the present invention. For example, a CCD (Charge Coupled Device) type or a CMOS (complementary metal oxide semiconductor) type image sensor, a silicon photodiode, or an InGaAs (Indium Gallium Arsenide) photodiode is used as the photodetector 28. The photodetector 28 detects the multiplexed light LC input from the beam splitter 22, that is, converts and amplifiers the multiplexed light LC into an electric signal under the control of the control device 16 and outputs a detection signal 29 of the multiplexed light LC to the control device 16.

The relative movement unit 14 is constituted by using various actuators (for example, actuators capable of performing a five-axis operation) such as a motor driving mechanism and is capable of displacing the position and the attitude of the probe 24. The relative movement unit 14 displaces the position and the attitude of the probe 24 under the control of the control device 16 to move the probe 24 relatively to the surface to be measured W in a state of being spaced a substantially fixed interval apart from the surface to be measured W along a measurement path 15 illustrated in FIG. 1. Accordingly, the surface to be measured W is scanned by the measurement light LA, whereby the detection of the multiplexed light LC by the photodetector 28 and the output of the interference signal 29 from the photodetector 28 are repeatedly executed for each of the measurement points Pm on the surface to be measured W.

Note that, instead of displacing the position and the attitude of the probe 24, the relative movement unit 14 may displace the position and the attitude of a stage supporting the surface to be measured W (the object to be measured) to relatively move the probe 24 along the measurement path 15.

The control device 16 collectively controls profile measurement for the surface to be measured W by the wavelength swept type interferometer 12 and the relative movement unit 14 and shape calculation for the surface to be measured W. The control device 16 includes an arithmetic circuit configured from various processors, memories, and the like. The various processors include a CPU (Central Processing Unit), a GPU (Graphics Processing Unit), an ASIC (Application Specific Integrated Circuit), and a programmable logic device [for example, an SPLD (Simple Programmable Logic Devices), a CPLD (Complex Programmable Logic Device), and an FPGA (Field Programmable Gate Arrays)]. Note that various functions of the control device 16 may be implemented by one processor or may be implemented by processors of the same type or different types.

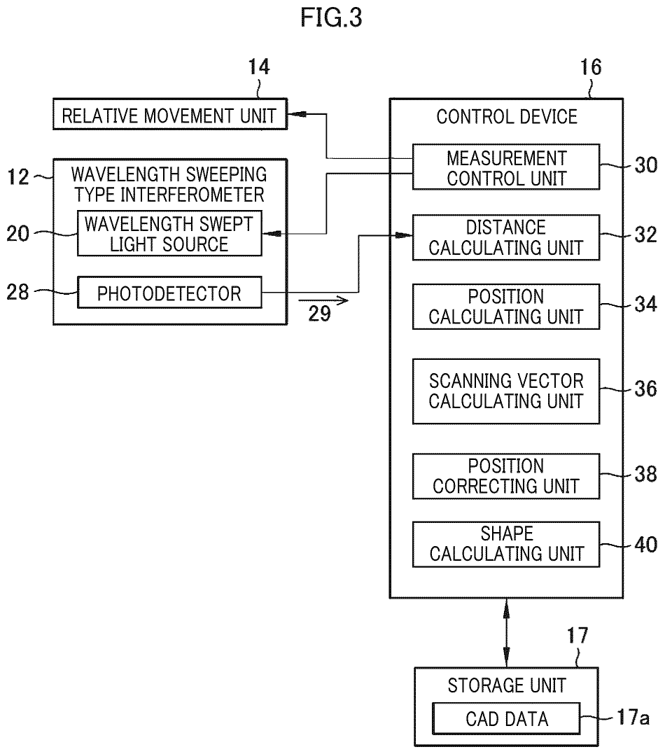

FIG. 3 is a functional block diagram of the control device 16. As illustrated in FIG. 3, the units of the wavelength swept type interferometer 12 and the relative movement unit 14 are connected to the control device 16. In addition, a storage unit 17 is provided in the control device 16. Besides a not-illustrated control program for the control device 16 and a shape calculation result for the surface to be measured W, the storage unit 17 stores CAD data 17a, which is shape data, of the surface to be measured W (the object to be measured) created in advance by CAD (Computer Aided Design). Note that the CAD data 17a may be stored in an external server on the Internet. Shape data other than a CAD format may be stored in the storage unit 17 as long as the shape data is data indicating the shape of the surface to be measured W.

The control device 16 executes the not-illustrated control program in the storage unit 17 to function as a measurement control unit 30, a distance calculating unit 32, a position calculating unit 34, a scanning direction vector calculating unit 36, a position correcting unit 38, and a shape calculating unit 40.

The measurement control unit 30 controls a profile measurement operation for the surface to be measured W by the wavelength swept type interferometer 12 and the relative movement unit 14. Specifically, according to measurement start operation for profile measurement for the surface to be measured W, the measurement control unit 30 causes the wavelength swept light source 20 to start emission of the wavelength swept light L and causes the photodetector 28 to repeatedly execute detection of the multiplexed light LC and output of the detection signal 29.

The measurement control unit 30 drives the relative movement unit 14 to move the probe 24 along the measurement path 15 illustrated in FIG. 1, that is, relatively move the probe 24 along the surface to be measured W in a state of being spaced a substantially fixed interval apart from the surface to be measured W.

Specifically, the measurement control unit 30 determines, based on the CAD data 17a of the surface to be measured W acquired from the storage unit 17, the measurement path 15 extending along the surface to be measured W in a state of being spaced a fixed interval apart from the surface to be measured W (an ideal surface to be measured W) assumed from the CAD data 17a.

Then, the measurement control unit 30 drives the relative movement unit 14 to align the probe 24 with a measurement start position of the determined measurement path 15 and thereafter move the probe 24 along the measurement path 15. Accordingly, the probe 24 is relatively moved along the surface to be measured W in a state of being spaced a substantially fixed interval apart from an actual surface to be measured W, whereby the surface to be measured W is scanned by the measurement light LA. Here, since a method of moving the probe 24 relatively to the surface to be measured W at the time of the profile measurement is a publicly-known technique, specific explanation of the method is omitted.

As explained above, in the profile measurement for the surface to be measured W, the surface to be measured W is scanned with the measurement light LA while relatively moving the probe 24 along the measurement path 15, and the detection of the multiplexed light LC is repeatedly performed by the photodetector 28, so that the detection of the multiplexed light LC and the output of the detection signal 29 by the photodetector 28 are executed for each of the measurement points Pm on the surface to be measured W. Accordingly, in the profile measurement for the surface to be measured W in the present embodiment, it is possible to detect an error between the shape of the ideal surface to be measured W assumed from the CAD data 17a and the shape of the actual surface to be measured W.

While the relative movement of the probe 24 along the measurement path 15 is performed, the distance calculating unit 32 calculates, for each of the measurement points Pm, a distance from the probe 24 to the measurement point Pm (hereinafter referred to as measurement distance) based on the detection signal 29 input from the photodetector 28.

Specifically, the distance calculating unit 32 executes a frequency analysis for the detection signal 29 (a beat signal) detected by the photodetector 28 and detects a beat frequency that is a frequency difference between the measurement light LA and the reference light LB. Here, since a method of detecting the beat frequency is a publicly-known technique, specific explanation of the method is omitted. The beat frequency and a reaching time difference between the measurement light LA and the reference light LB from the wavelength swept light source 20 to the photodetector 28 are proportional to the measurement distance. For this reason, the distance calculating unit 32 calculates the measurement distance based on a detection result of the beat frequency with reference to a [Math. 1] Expression described below. Here, “Df” in the [Math. 1] Expression is a conversion factor. The conversion factor Df is set based on an experiment or a simulation performed in advance.

$$Measurement distance = Df \times beat frequency \qquad [ Math . 1 ]$$

Thereafter, similarly, the distance calculating unit 32 executes, for each of the measurement points Pm, the frequency analysis for the detection signal 29 (the detection of the beat frequency) and the calculation of the measurement distance using the [Math. 1] Expression described above.

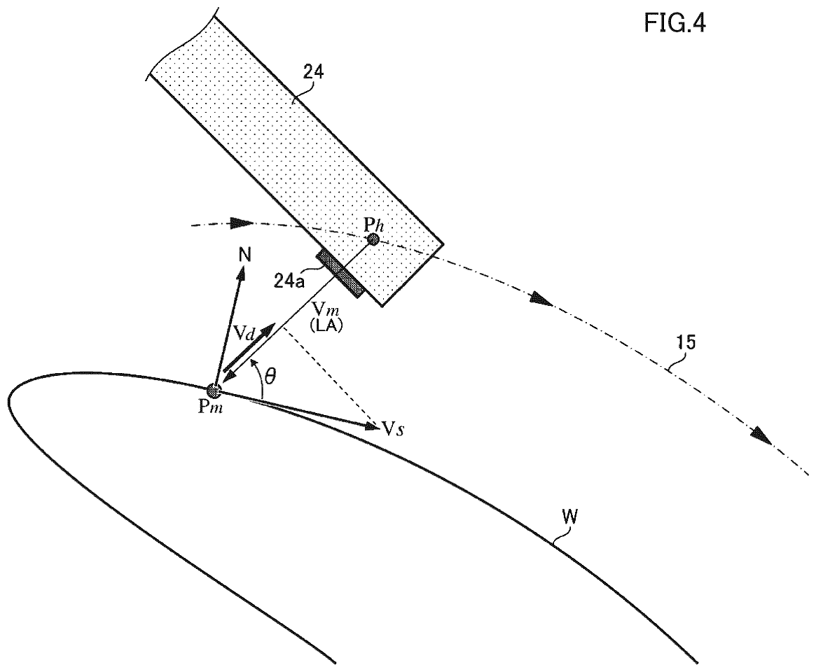

The position calculating unit 34 calculates, for each of the measurement points Pm, a position of the measurement point Pm based on a calculation result of the distance calculating unit 32 corresponding to the measurement point Pm, and a position (a position of a reference point Ph explained below; see FIG. 4) and an attitude (an angle) of the probe 24 corresponding to the measurement point Pm.

FIG. 4 is an explanatory diagram for explaining a problem in performing profile measurement for the curved surface-shaped (curved-shaped) surface to be measured W in a noncontact manner. Here, a character Ph in the figure is a predetermined reference point in the probe 24. The distance calculating unit 32 explained above calculates the distance between the reference point Ph and the measurement point Pm as a measurement distance. A character Vm in the figure is a measurement light vector from the reference point Ph to the measurement point Pm. A character N in the figure is a normal direction of the surface to be measured W at the measurement point Pm. A character Vs in the figure is a scanning direction vector of the measurement light LA for scanning the surface to be measured W and is a scanning direction vector (a speed vector) parallel to the tangential direction of the surface to be measured W at the measurement point Pm.

As illustrated in FIG. 4, when the profile measurement for the curved surface-shaped surface to be measured W is performed, an incident angle of the measurement light LA incident on the measurement points Pm (in the figure, one measurement point Pm is illustrated as a representative example) from the probe 24 is not perpendicular (parallel to the normal direction N) because of a curvature of the surface to be measured W, a restriction in a holding method of the probe 24 by the relative movement unit 14, and the like. In this case, a scanning direction vector Vs also has a component (hereinafter referred to as measurement light direction component Vd) in the direction (equivalent to the measurement light direction of the present invention) of a measurement light vector Vm. When an angle formed by the scanning direction vector Vs and the measurement light vector Vm is represented as θ, the measurement light direction component Vd is represented by a [Math. 2] Expression described below.

$$Vd = - Vm / \vert Vm \vert \times \vert Vs \vert \times COS ( θ ) \qquad [ Math . 2 ]$$

When the measurement light direction component Vd occurs in this way, although a measurement distance |Pm−Ph| is fixed, a state is the same as a state in which the measurement points Pm (the surface to be measured W) are closer to the probe 24 by the measurement light direction component Vd indicated by the [Math. 2] Expression described above. Accordingly, a Doppler shift in which frequencies of measurement lights LA respectively reflected at the measurement points Pm are shifted by the Doppler effect occurs. As a result, since an error occurs in a measurement distance for each of the measurement points Pm calculated by the distance calculating unit 32, an error also occurs in the position of each of the measurement points Pm calculated by the position calculating unit 34.

Therefore, in the present embodiment, for each of the measurement points Pm, a position of the measurement point Pm calculated by the position calculating unit 34 is corrected based on a Doppler shift amount of the measurement light LA. Specifically, in the present embodiment, for each of the measurement points Pm, the calculation of the scanning direction vector Vs by the scanning direction vector calculating unit 36 and the position correction for the measurement point Pm by the position correcting unit 38 are repeatedly performed. Note that, in the present embodiment, since the position measurement for the first measurement point Pm is performed in a state in which the probe 24 is stopped with respect to the surface to be measured W, the Doppler shift of the measurement light LA does not occur. For this reason, the calculation of the scanning direction vector Vs and the position correction for the measurement point Pm explained above are repeatedly performed for each of the second and subsequent measurement points Pm.

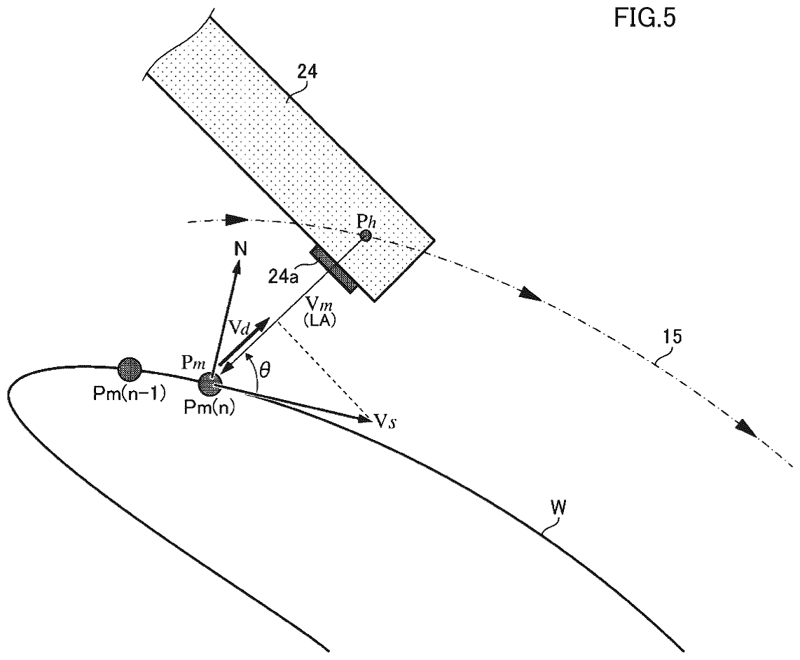

FIG. 5 is an explanatory diagram for explaining the calculation of the scanning direction vector Vs by the scanning direction vector calculating unit 36. As illustrated in FIG. 5 and FIG. 3 referred to above, the scanning direction vector calculating unit 36 calculates a magnitude (length) of the scanning direction vector Vs for each of the second and subsequent measurement points Pm. For example, when the latest measurement point Pm is represented as Pm(n), the immediately preceding measurement point Pm is represented as Pm(n−1), and a scanning time of the measurement light LA from Pm(n−1) to Pm(n) is represented as “T”, the scanning direction vector calculating unit 36 approximately calculates the scanning direction vector Vs according to a [Math. 3] Expression described below. Then, the scanning direction vector calculating unit 36 executes arithmetic processing of the [Math. 3] Expression for each of the measurement points Pm to calculate the scanning direction vector Vs for each of the second and subsequent measurement points Pm.

$$Vs ( mm / s ) = [ Pm ( n - 1 ) - Pm ( n ) ] / T \qquad [ Math . 3 ]$$

The position correcting unit 38 corrects, for each of the second and subsequent measurement points Pm, a position of the measurement point Pm calculated by the position calculating unit 34 based on a Doppler shift amount in a frequency of the measurement light LA reflected at the measurement point Pm. Specifically, when the measurement point Pm after the position correction is represented as “corrected measurement point Pmc”, the position of the corrected measurement point Pmc is represented by a [Math. 4] Expression described below based on the position of the measurement point Pm before the correction, the conversion factor Df explained above, and the measurement light direction component Vd and a Doppler shift amount [fd (Hz)] corresponding to the measurement point Pm before the correction.

$$Pmc = Pm + Df \times fd \times Vd / \vert Vd \vert \qquad [ Math . 4 ]$$

Here, when a wavelength of the measurement light LA is represented as “λ (μm)”, the Doppler shift amount [fd(Hz)] is represented by a [Math. 5] Expression described below. For this reason, the [Math. 4] Expression described above may be transformed into a [Math. 6] Expression described below based on the [Math. 5] Expression. Note that, in the [Math. 5] Expression, although the wavelength λ of the measurement light LA is a variable, a frequency v (v=C/λ) of the measurement light LA may be the variable instead of the wavelength λ.

$$fd ( Hz ) = 2 \times \vert Vd \vert ( mm / s ) / [ λ ( μm ) \times 0.0 \; 01 ] \qquad [ Math . 5 ]$$

$$[ Math . 6 ]$$

$$Pmc = Pm + Df \times \{ 2 \times \vert Vd \vert ( mm / s ) / [ λ ( μm ) \times 0.001 ] \} \times Vd / \vert Vd \vert = Pm + Df \times 2 \times ( mm / s ) / [ λ ( μm ) \times 0.001 ]$$

In the [Math. 6] Expression described above, the measurement light direction component Vd (mm/s) is represented by the [Math. 2] Expression described above. For this reason, the [Math. 6] Expression described above can be transformed into a [Math. 7] Expression described below based on the [Math. 2] Expression.

$$[ Math . 7 ]$$

$$Pmc = Pm + Df \times 2 \times \{ - Vm / \vert Vm \vert \times \vert Vs \vert \times COS ( θ ) \} ( mm / s ) / [ λ ( μm ) \times 0.001 ]$$

Here, COS(θ) in the [Math. 7] Expression is represented by a [Math. 8] Expression described below based on the scanning direction vector Vs and the measurement light vector Vm according to the publicly-known vector inner product definition. Note that the measurement light vector Vm may be calculated for each of the measurement points Pm based on the position of the reference point Ph of each of known measurement points Pm and the position of the measurement point Pm calculated by the position calculating unit 34 for each of the measurement points Pm.

$$COS ( θ ) = Vs \times ( - Vm ) / ( \vert Vs \vert \vert Vm \vert ) \qquad [ Math . 8 ]$$

Therefore, the position correcting unit 38 substitutes, for each of the second subsequent measurement points Pm, a calculation result of the scanning direction vector Vs by the scanning direction vector calculating unit 36, a calculation result of the measurement light vector Vm, for example, calculated by the position correcting unit 38, and the wavelength of the measurement light LA acquired from the wavelength swept light source 20 in the [Math. 7] Expression and the [Math. 8] Expression described above, to calculate a position of the corrected measurement point Pmc.

Note that, for each of the second and subsequent measurement points Pm, the position correcting unit 38 may firstly calculate the Doppler shift amount fd based on the [Math. 5] Expression and the like described above and then calculate the position of the corrected measurement point Pmc based on the [Math. 4] Expression described above. In this case, the position correcting unit 38 functions as a Doppler shift amount calculating unit that calculates the Doppler shift amount fd.

The shape calculating unit 40 calculates a shape (a surface shape, a contour shape, or the like) of the surface to be measured W based on the position of the first measurement point Pm calculated by the position calculating unit 34 and the positions of the second and subsequent corrected measurement points Pmc calculated by the position correcting unit 38. Note that the shape calculating unit 40 may calculate the shape of the surface to be measured W based on only the positions of the corrected measurement points Pmc.

### Action of the Present Embodiment

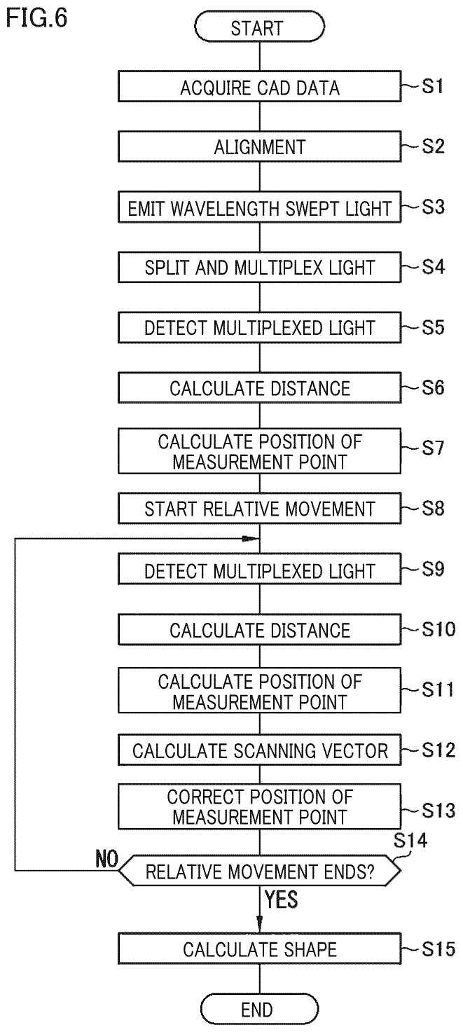

FIG. 6 is a flowchart illustrating a flow of profile measurement processing for the surface to be measured W by the profile measurement device 10 having the configuration explained above relating to the shape measuring method of the present invention. As illustrated in FIG. 6, when a tester sets the surface to be measured W (the object to be measured) in the profile measurement device 10 and thereafter performs measurement start operation with a not-illustrated operation unit, the measurement control unit 30 acquires the CAD data 17a of the surface to be measured W from the storage unit 17 and determines the measurement path 15 based on the CAD data 17a (step S1).

Subsequently, the measurement control unit 30 drives the relative movement unit 14 to perform alignment for moving the probe 24 to the determined measurement start position of the measurement path 15 (step S2). The measurement control unit 30 causes the wavelength swept light source 20 to start emission of the wavelength swept light L (step S3).

The wavelength swept light L is optically split into the measurement light LA and the reference light LB by the beam splitter 22. The measurement light LA is made incident on the first measurement point Pm on the surface to be measured W and the reference light LB is made incident on the reference surface 26 (step S4; equivalent to the light dividing step of the present invention). Then, the measurement light LA reflected at the first measurement point Pm and the reference light LB reflected on the reference surface 26 are multiplexed by the beam splitter 22 and, thereafter, the multiplexed light LC of the measurement light LA and the reference light LB is made incident on the photodetector 28 (step S4; equivalent to the multiplexing step of the present invention).

The measurement control unit 30 causes, according to the emission of the wavelength swept light L from the wavelength swept light source 20, the photodetector 28 to start detection of the multiplexed light LC and output of the detection signal 29 (step S5).

When the detection signal 29 corresponding to the first measurement point Pm is output from the photodetector 28, the distance calculating unit 32 executes a frequency analysis for the detection signal 29 to detect a beat frequency and calculates a measurement distance corresponding to the first measurement point Pm based on a detection result of the beat frequency using the [Math. 1] Expression described above (step S6). The position calculating unit 34 calculates a position of the first measurement point Pm based on the distance detection result for the first measurement point Pm by the distance calculating unit 32 and the position and the attitude (the angle) of the reference point Ph of the probe 24 (step S7).

Subsequently, the measurement control unit 30 drives the relative movement unit 14 to move the probe 24 along the measurement path 15. Accordingly, the probe 24 is relatively moved along the surface to be measured W in a state of being spaced a substantially fixed interval apart from the actual surface to be measured W, and the surface to be measured W is scanned by the measurement light LA (step S8; equivalent to the relative movement step of the present invention). When scanning with the measurement light LA has been performed for a fixed distance (a scanning time T) from the first measurement point Pm on the surface to be measured W and the measurement light LA is made incident on the second measurement point Pm, the measurement control unit 30 causes the photodetector 28 to execute detection of the multiplexed light LC and output of the detection signal 29 (step S9; equivalent to the detecting step of the present invention).

When the detection signal 29 corresponding to the second measurement point Pm is output from the photodetector 28, as at the time of the detection of the position of the first measurement point Pm, calculation of a measurement distance corresponding to the second measurement point Pm is executed by the distance calculating unit 32 (step S10) and calculation of a position of the second measurement point Pm is executed by the position calculating unit 34 (step S11). Here, step S10 is equivalent to the distance calculating step of the present invention and step S11 is equivalent to the position calculating step of the present invention.

When the position calculation for the second measurement point Pm is completed, the scanning direction vector calculating unit 36 calculates the scanning direction vector Vs corresponding to the second measurement point Pm, based on the position of the first measurement point Pm which is the immediately preceding of the second measurement point Pm, the position of the second measurement point Pm, and the scanning time T between the first measurement point Pm and the second measurement point Pm, using the [Math. 3] Expression described above (step S12).

Subsequently, the position correcting unit 38 calculates the measurement light vector Vm corresponding to the second measurement point Pm, based on the position of the reference point Ph corresponding to the second measurement point Pm and the position of the second measurement point Pm calculated by the position calculating unit 34. The position correcting unit 38 acquires the wavelength λ (or the frequency v) of the measurement light LA corresponding to the second measurement point Pm from the wavelength swept light source 20.

Then, the position correcting unit 38 calculates a position of the corrected measurement point Pmc, based on a calculation result of the scanning direction vector Vs corresponding to the second measurement point Pm, a calculation result of the measurement light vector Vm and a wavelength of the measurement light LA, using the [Math. 7] Expression and the [Math. 8] Expression described above. Accordingly, the position of the second measurement point Pm may be corrected based on a Doppler shift amount of the measurement light LA at the second measurement point Pm (step S13; equivalent to the position correcting step of the present invention).

Thereafter, while the relative movement of the probe 24 along the measurement path 15 is performed (NO in step S14), the processing in step S9 to step S13 explained above is repeatedly executed for each of third and subsequent measurement points Pm. Accordingly, the positions of the third and subsequent measurement points Pm are corrected, whereby positions of the third and subsequent corrected measurement points Pmc are calculated.

When the relative movement of the probe 24 is completed (YES in step S14), the shape calculating unit 40 calculates a shape of the surface to be measured W based on the position of the first measurement point Pm calculated in step S7 and the positions of the corrected measurement points Pmc calculated in step S9 (step S15).

### Effects of the Present Embodiment

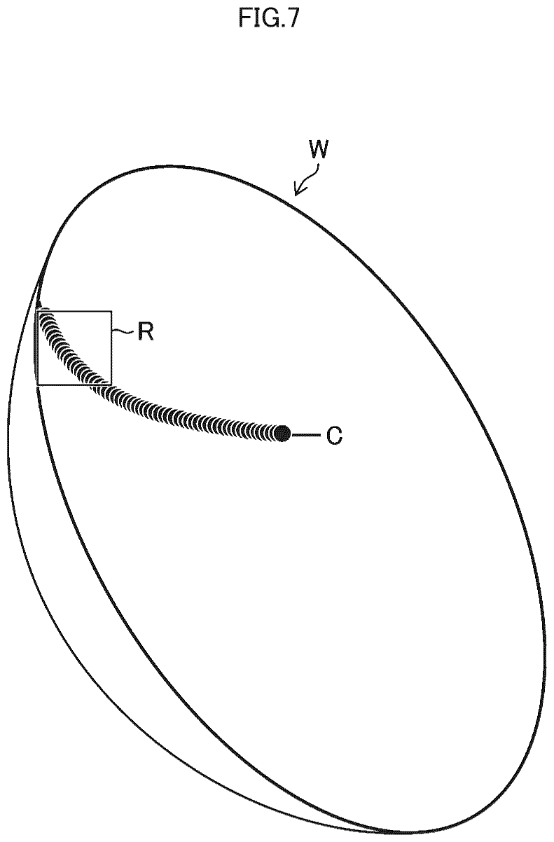

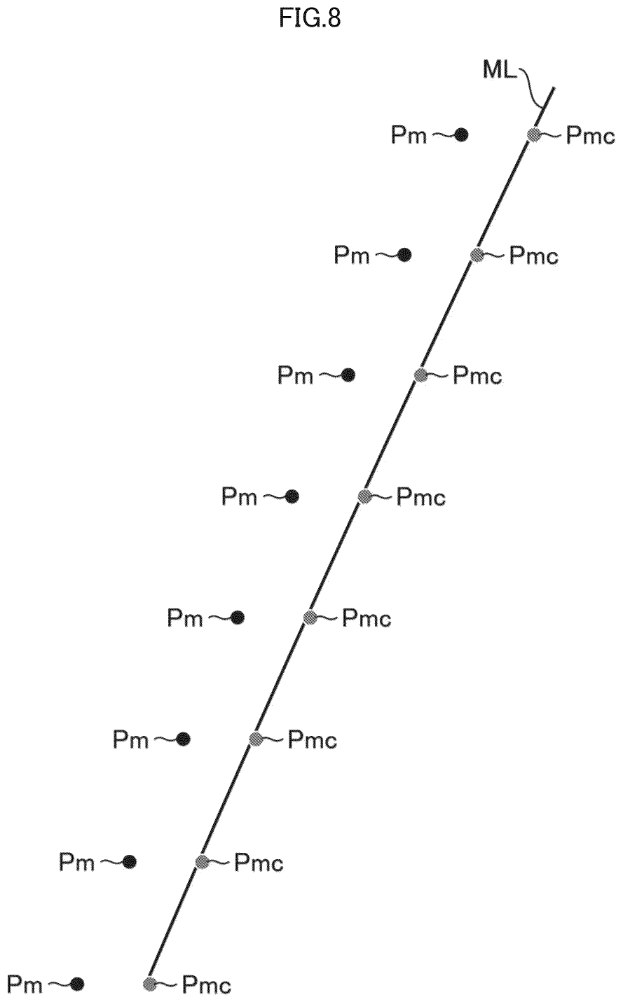

FIG. 7 is a diagram illustrating an example of the surface to be measured W for which the profile measurement has been performed by the profile measurement device 10 in the present embodiment. FIG. 8 is a graph which compares the positions of the measurement points Pm and the corrected measurement points Pmc obtained by performing the profile measurement within a measurement range R of the surface to be measured W illustrated in FIG. 7 with the profile measurement device 10 and the positions of the measurement points Pm obtained by measuring the measurement points Pm with a contact type distance meter (not illustrated).

As illustrated in FIG. 7, using a part of the surface of a calibration ball having φ25 mm as the surface to be measured W, the profile measurement was performed along a measurement line C on the surface to be measured W by the profile measurement device 10 according to the present embodiment. In addition, the positions of the measurement points Pm measured by the profile measurement device 10, were measured by the contact type distance meter. As illustrated in FIG. 8, the positions of the measurement points Pm obtained by the profile measurement by the profile measurement device 10 deviate from interpolation curves ML of the measurement points Pm measured by the contact type profile measurement device because of the influence of a Doppler shift.

In contrast, it was confirmed that the positions of the corrected measurement points Pmc corrected by the position correcting unit 38 coincided with the interpolation curves ML irrespective of a direction (a forward path or a backward path) of the profile measurement. Therefore, as in the present embodiment the positions of the measurement points Pm obtained by the profile measurement may be corrected based on the Doppler shift amount, so as to reduce an error in a measured shape of the surface to be measured W due to a Doppler shift.

### Others

The wavelength swept type interferometer 12 used in the embodiment explained above is not limited to the wavelength swept type interferometer 12 illustrated in FIG. 2. A type of the wavelength swept type interferometer 12 is not particularly limited.

In the embodiment explained above, the profile measurement is performed by the profile measurement device 10 for cases respectively using the blade surface and the spherical surface as the surface to be measured W, for examples. However, the present invention may be applied to a case in which profile measurement is performed for other nonhorizontal surfaces such as a curved surface and an inclined surface.

The present invention is applicable to various shape measuring devices that, irrespective of the shape of the surface to be measured W, perform shape measurement for the surface to be measured W while moving the probe 24 relatively to the surface to be measured W in a state in which the measurement light LA is incident from the probe 24 in an oblique direction with respect to the surface to be measured W.

Further, in the present invention, when the measurement light LA is perpendicularly incident on the surface to be measured W from the probe 24, since COS(θ) in the [Math. 2] Expression described above is zero, the measurement light direction component Vd (the Doppler shift amount fd) is also zero. As a result, since the corrected measurement point Pmc calculated by the position correcting unit 38 coincides with the measurement point Pm before the correction, even if the correction by the position correcting unit 38 is performed, the shape measurement result of the surface to be measured W is not affected. Therefore, the present invention is applicable to various shape measuring devices that, irrespective of an incident direction of the measurement light LA on the surface to be measured W, perform the shape measurement for the surface to be measured W while moving the probe 24 relatively to the surface to be measured W.

### REFERENCE SIGNS LIST

10 Measurement device
12 Wavelength swept type interferometer
14 Relative movement unit
15 Measurement path
16 Control device
17 Storage unit
17a CAD data
20 Wavelength swept light source
22 Beam splitter
24 Probe
24a Incidence and emission end
26 Reference surface
28 Photodetector
29 Detection signal
30 Measurement control unit
32 Distance calculating unit
34 Position calculating unit
36 Scanning direction vector calculating unit
38 Position correcting unit
40 Shape calculating unit
C Measurement line
Df Conversion factor
L Wavelength swept light
LA Measurement light
LB Reference light
LC Multiplexed light
ML Interpolation curve
N Normal direction
Ph Reference point
Pm Measurement point
Pmc Corrected measurement point
R Measurement range
T Scanning time
Vd Measurement light direction component
Vm Measurement light vector
Vs Scanning direction vector
W Surface to be measured
fd Doppler shift amount

What is claimed is:

1. A shape measuring device comprising:
a wavelength swept light source configured to emit light whose frequency is modulated to have a sinusoidal waveform;
a light dividing configured to split the light emitted from the wavelength swept light source into measurement light and reference light;
a probe configured to emit the measurement light split by the light dividing unit toward a surface to be measured and receive the measurement light reflected on the surface to be measured;
a reference surface configured to reflect the reference light split by the light dividing unit;
a multiplexing unit configured to generate multiplexed light of the measurement light reflected on the surface to be measured and received by the probe, and the reference light reflected on the reference surface;
a relative movement unit configured to relatively move the probe along the surface to be measured in a state of being spaced an interval apart from the surface to be measured, and scan the surface to be measured with the measurement light;
a detecting unit configured to, while relative movement of the prove is performed, repeatedly detect the multiplexed light generated by the multiplexing unit, for each measurement point on the surface to be measured on which the measurement light is incident;
a distance calculating unit configured to detect a beat frequency from a detection signal of the multiplexed light detected by the detecting unit and calculate a distance from the probe to the measurement point based on the beat frequency, for each measurement point;
a position calculating unit configured to calculate a position of the measurement point based on a calculation result of the distance calculating unit corresponding to the measurement point, for each measurement point;
a position correcting unit configured to correct the position of the measurement point calculated by the position calculating unit based on a Doppler shift amount of the measurement light reflected at the measurement point, for each measurement point; and
a scanning direction vector calculating unit configured to calculate, for each measurement point, a magnitude of a scanning direction vector of the measurement light for scanning the surface to be measured, the scanning direction vector being parallel to a tangential direction of the surface to be measured at the measurement point, wherein
in a case where a direction of the measurement light between the probe and the measurement point is represented as a measurement light direction, the position correcting unit calculates, for each measurement point, the Doppler shift amount based on a component parallel to the measurement light direction of the scanning direction vector calculated by the scanning direction vector calculating unit and a wavelength or a frequency of the measurement light.

2. The shape measuring device according to claim 1, wherein, based on shape data of the surface to be measured created in advance, the relative movement unit relatively moves the probe along the surface to be measured in a state of being spaced a fixed interval apart from the surface to be measured which is assumed from the shape data.

3. The shape measuring device according to claim 1, wherein the probe makes the measurement light incident on the surface to be measured from an oblique direction.

4. A shape measuring method comprising:
a light dividing step of dividing light emitted from a wavelength swept light source configured to emit the light whose frequency is modulated to have a sinusoidal waveform, into measurement light and reference light, to emit the measurement light from a probe toward a surface to be measured and to emit the reference light toward a reference surface;
a multiplexing step of generating multiplexed light of the measurement light reflected on the surface to be measured and received by the probe, and the reference light reflected on the reference surface;
a relative movement step of relatively moving the probe along the surface to be measured in a state of being spaced an interval apart from the surface to be measured, and scanning the surface to be measured with the measurement light;
a detecting step of, during the relative movement step, repeatedly detecting the multiplexed light generated in the multiplexing step, for each measurement point of the surface to be measured on which the measurement light is incident;
a distance calculating step of detecting a beat frequency from a detection signal of the multiplexed light detected in the detecting step and calculating a distance from the probe to the measurement point based on the beat frequency, for each measurement point;
a position calculating step of calculating a position of the measurement point based on a calculation result of the distance calculating step corresponding to the measurement point, for each measurement point;
a position correcting step of collecting the position of the measurement point calculated in the position calculating step based on a Doppler shift amount of the measurement light reflected at the measurement point, for each measurement point; and
a scanning direction vector calculating step of calculating, for each measurement point, a magnitude of a scanning direction vector of the measurement light for scanning the surface to be measured, the scanning direction vector being parallel to a tangential direction of the surface to be measured at the measurement point, wherein
in a case where a direction of the measurement light between the probe and the measurement point is represented as a measurement light direction, in the position correcting step, the Doppler shift amount is calculated for each measurement point based on a component parallel to the measurement light direction of the scanning direction vector calculated in the scanning direction vector calculating step and a wavelength or a frequency of the measurement light.
